(19) United States
(12) Patent Application Publication
(10) Pub. No.: US 2008/0046842 A1
(43) Pub. Date: Feb. 21, 2008

(54) METHOD AND APPARATUS FOR EXECUTING APPLICATION IN A PORTABLE TERMINAL

(75) Inventor: Ji-Sun KIM, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/841,467

(22) Filed: Aug. 20, 2007

(30) Foreign Application Priority Data
Aug. 21, 2006 (KR) 2006-0078565

(51) Int. Cl. G06F 3/048

(52) U.S. Cl. 715/847

(57) ABSTRACT

Provided are a method and an apparatus for executing an application in a portable terminal. The method includes checking if a shortcut key preset in a launcher program is input; confirming whether the preset shortcut key is designated as one of an individual item and a corresponding list; if the preset shortcut key is designated as the individual item, displaying a number of the preset shortcut key and a name of the individual item; and executing the individual item according to a shortcut key execution designation command.

### PRIORITY

This application claims priority under 35 U.S.C. § 119 to an application filed in the Korean Intellectual Property Office on Aug. 21, 2006, entitled “Method and Apparatus for Executing Application in a Portable Terminal” and assigned Serial No. 2006-78565, the contents of which are incorporated herein by reference.

### BACKGROUND OF THE INVENTION

1. Field of the Invention

The present invention relates generally to a launcher program used in a portable terminal, and in particular, to an apparatus and a method for allowing a user to actively search for and execute desired application, file, and folder, supporting a shortcut key function to instantly execute a designated application, and providing a task manager function so that an application executes functions of two applications which have been used, in a portable terminal.

2. Description of the Related Art

Portable terminals have evolved rapidly and thus recently these terminals are able to support various functions. In addition, a variety of application programs, media files, and document files became available with increased capacities in the external memories used in terminals.

Launcher programs are provided in portable terminals to provide users with easy access to application programs, document files, media files, etc. Such a launcher program is used by a user to pre-register and execute desired application program, media file, document file, etc. Thus, the user can quickly execute the application program and easily open the media or document file. In addition, a user uses a task manager program to display an application, which is currently being used, and stop the corresponding application if necessary. Here, application programs, media files, document files, etc., other items, which can be registered in a launcher program, will be referred as to items.

An existing launcher program allows users to passively execute items, classify the items into several groups, pre-register the several groups, and select and execute items of the several groups desired by the users.

FIG. 1A illustrates the main screen of a conventional launcher program.

Referring to FIG. 1A, items registered in the conventional launcher program are displayed on the main screen. A user may move to an application group or execute items registered in the application group on the main screen.

FIG. 1B illustrates a screen for managing applications of groups registered in the conventional launcher program.

Referring to FIG. 1B, application list contents of the group “MITs” registered in the conventional launcher program are revised to add, move, or delete a corresponding application on the screen.

FIG. 1C illustrates a screen for registering an application desired by a user in the conventional launcher program.

Referring to FIG. 1C, in order to register a desired application during setting of the conventional launcher program, the user may move to a specific directory of a system in which the desired application is positioned. Thereafter, the user may search the specific directory for an execution file of the desired application.

FIG. 2A illustrates the main screen of a task manager.

Referring to FIG. 2A, the task manager displays to a user an application list, which is currently being used, so that the user may stop a corresponding application if necessary.

FIG. 2B illustrates a screen for setting menus of the task manager.

Referring to FIG. 2B, the user may activate or stop an application, which is being executed, on a menu screen.

A launcher program and a task manager program as described above operate as two separate applications.

The greatest problem of a conventional launcher program is that items registered in the launcher program are limited. In other words, a programmer pre-registers items, and a user selects and executes a desired item of the pre-registered items. In this case, items that are not used by the user may be registered or items the user requires may not be registered. Alternatively, the user may personally register and use desired items. However, the number of items the user can register is limited, and the user must remember and register positions of corresponding objects one by one. Also, since several processes must be performed to register a group or an item, it may be inconvenient to use the conventional launcher program.

Since the launcher program and the task manager program operate as two separate applications, the task manager program must be used to activate and stop an item, which is executing the launcher program, in order to execute a desired item. The two separate applications use the same icon or string to display items but use different resources. This may cause waste of memory.

Accordingly, there is provided an apparatus and a method for integrating functions of a launcher program and a task manager by which a user can rapidly and easily execute an application from a portable terminal and prevent memory from being wasted.

### SUMMARY OF THE INVENTION

An aspect of the present invention is to solve at least the above problems and/or disadvantages and to provide at least the advantages below. Accordingly, an aspect of the present invention is to provide an apparatus and a method for executing a launcher program in a portable terminal.

Another aspect of the present invention is to provide an apparatus and a method for easily searching for and executing all applications supported in a portable terminal.

A further aspect of the present invention is to provide an apparatus and a method for integrating functions of a launcher program and a task manager to prevent memory from being wasted in a portable terminal.

The above aspects are achieved by providing a point-to-point emulation apparatus and method in a broadband wireless communication system.

According to one aspect of the present invention, there is provided a method of executing an application in a portable terminal, including checking if a shortcut key preset in a launcher program is activated; confirming whether the preset shortcut key is designated as one of an individual item and a list item or as the individual item, displaying a number of the preset shortcut key and a name of the individual item; and executing the individual item according to a shortcut key execution designation command.

According to another aspect of the present invention, there is provided a method of executing an application in a portable terminal, including inputting a letter into an input search window of a launcher program; outputting a list searched for items comprising the input letter; and selecting and executing a corresponding item of the output list.

According to a further aspect of the present invention, there is provided an apparatus for executing an application in a portable terminal, including a controller checking whether a shortcut key preset in a launcher program is activated, checking whether the preset shortcut key is designated as an individual item or a list item or as the individual item, displaying a number of the preset shortcut key and a name of the individual item, and executing the individual item according to a shortcut key execution designation command; and a program storage storing the individual item.

According still to another aspect of the present invention, there is provided an apparatus for executing an application in a portable terminal, including an input unit inputting a letter into an input search window of a launcher program; a controller searching for items comprising the input letter to output a list item, and if an item is selected from the output list item, executing the selected item; and a program storage storing the selected item.

### BRIEF DESCRIPTION OF THE DRAWINGS

The above and other objects, features and advantages of the present invention will become more apparent from the following detailed description when taken in conjunction with the accompanying drawings in which:

FIG. 1A illustrates the main screen of a conventional launcher program;

FIG. 1B illustrates a screen for revising an application of a group registered in the conventional launcher program;

FIG. 1C illustrates a screen for registering an application desired by a user in the conventional launcher program;

FIG. 2A illustrates a main screen of a task manager;

FIG. 2B illustrates a screen for setting menus of the task manager;

FIG. 3A shows an initial screen of a launcher program according to the present invention;

FIG. 3B shows a screen on which the letter “L” is displayed in an input window of the launcher program according to the present invention;

FIG. 3C shows a screen on which letters “LA” are displayed in the input window of the launcher program according to the present invention;

FIG. 3D shows the screen of 3B displaying an application, which is being executed, using a symbol in the launcher program according to the present invention;

FIG. 4A shows a screen using a shortcut key connected to an application program in a launcher program according to the present invention;

FIG. 4B shows a screen using a shortcut key connected to search conditions in the launcher program according to the present invention;

FIG. 5 illustrates a list item searched through inputs of letters in a launcher program according to the present invention;

FIGS. 6A and 6B illustrate a relationship between a menu of a launcher program and inputs of letters or uses of shortcut keys according to the present invention;

FIG. 7 is a flowchart of a method of executing an item using a shortcut key in a launcher program according to the present invention;

FIG. 8 is a flowchart of a method of executing an item using input letters in a launcher program according to the present invention; and

FIG. 9 is a block diagram of an apparatus for executing an item using a launcher program according to the present invention.

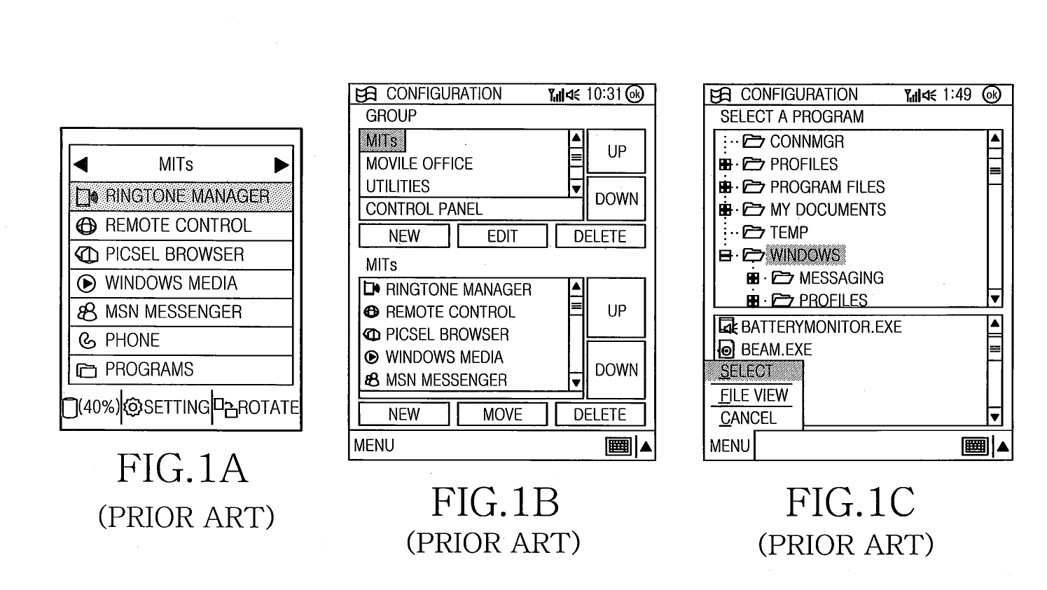

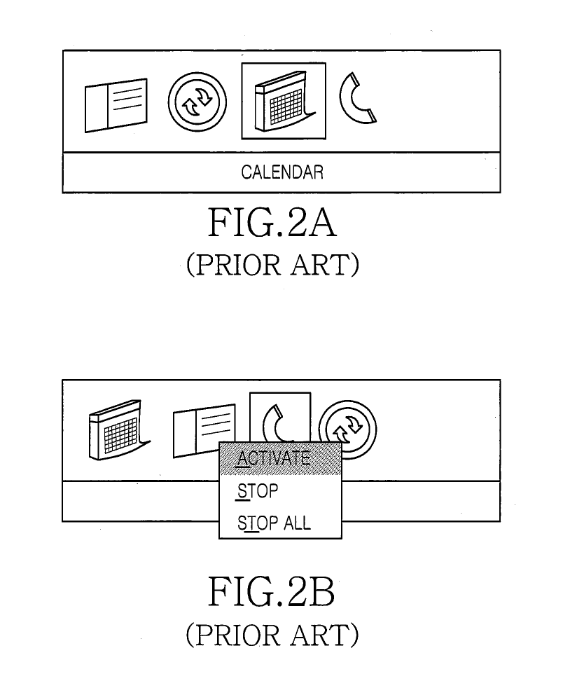

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides a method and an apparatus for executing an item using a launcher program including a function of a task manager in a portable terminal.

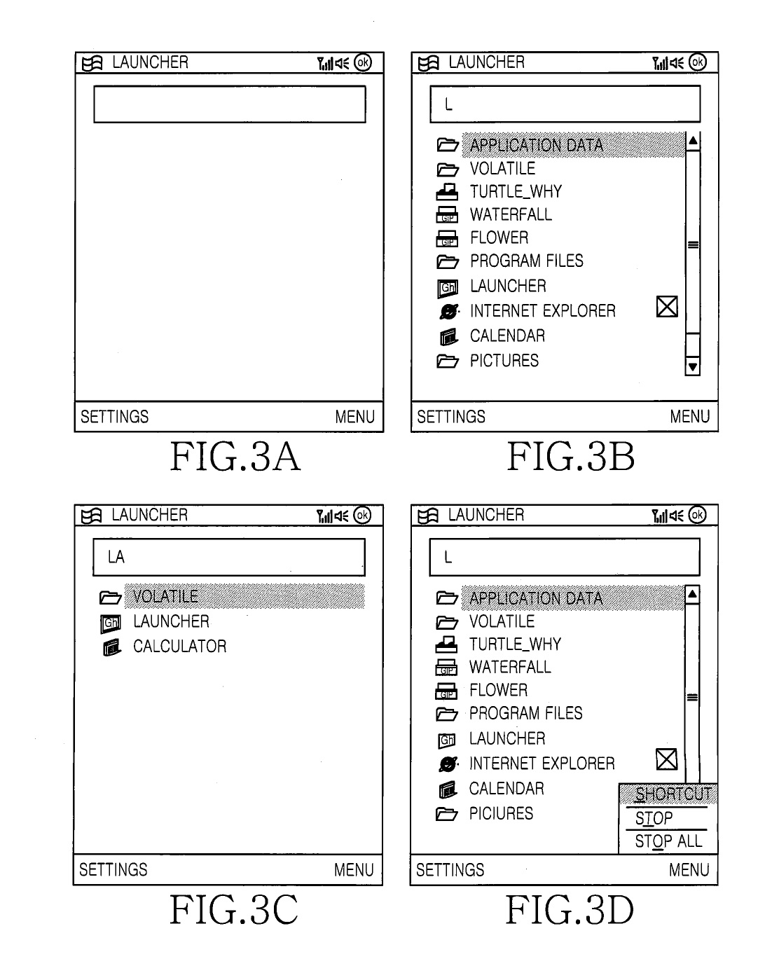

Referring to FIG. 3A, a user can input a letter or a letter string into an input search window of the launcher program to search for a desired application, file, or folder.

Referring to FIG. 3B, if the user starts inputting a letter, executable applications, files, and folders, which include the corresponding letter or letter string are searched constituting a list. Here, the executable applications, files, and folders are searched taking into consideration certain conditions designated through setting, and a new list is constituted and displayed whenever a letter is input, in order to confirm objects including the corresponding letter or letter string. For example, if the letter “L” is input, items, which include the letter “L” are instantly displayed.

Referring to FIG. 3C, if a letter “A” is input after the letter “L”, items, which include a letter string “LA” are displayed.

Referring to FIG. 3D, the execution state of a corresponding application is displayed to a user using the symbol [symbol] on a screen on which all designated items including the letter “L” are searched. The corresponding application may instantly stop if the user desires to do so. Also, a selected item is instantly registered with a shortcut key.

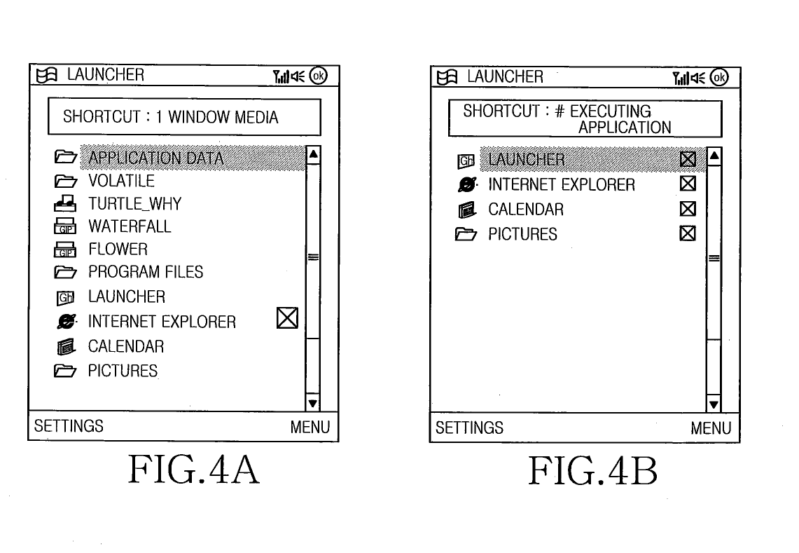

Referring to FIG. 4A, a user may search for a letter designating a desired item or may pre-register and use the desired item with a shortcut key. If a shortcut key is pressed, the contents of the designated item may be displayed to prevent an undesired item from being executed. For example, if a shortcut key “1” connected to an application program “Window Media” is pressed by the user for a long time, the number “1” of the shortcut key and the name “Window Media” of the corresponding item are displayed in an input window. Here, the shortcut key may designate a specific application, file, or folder for execution.

Referring to FIG. 4B, if the individual item and a shortcut key are pressed, items of the corresponding list may be displayed. All applications, all Uniform Resource Locator (URL) files, etc. may be designated to display desired items on a list as preview of an application being executed. Here, a shortcut key “#” is designated as a preview of an application currently being executed.

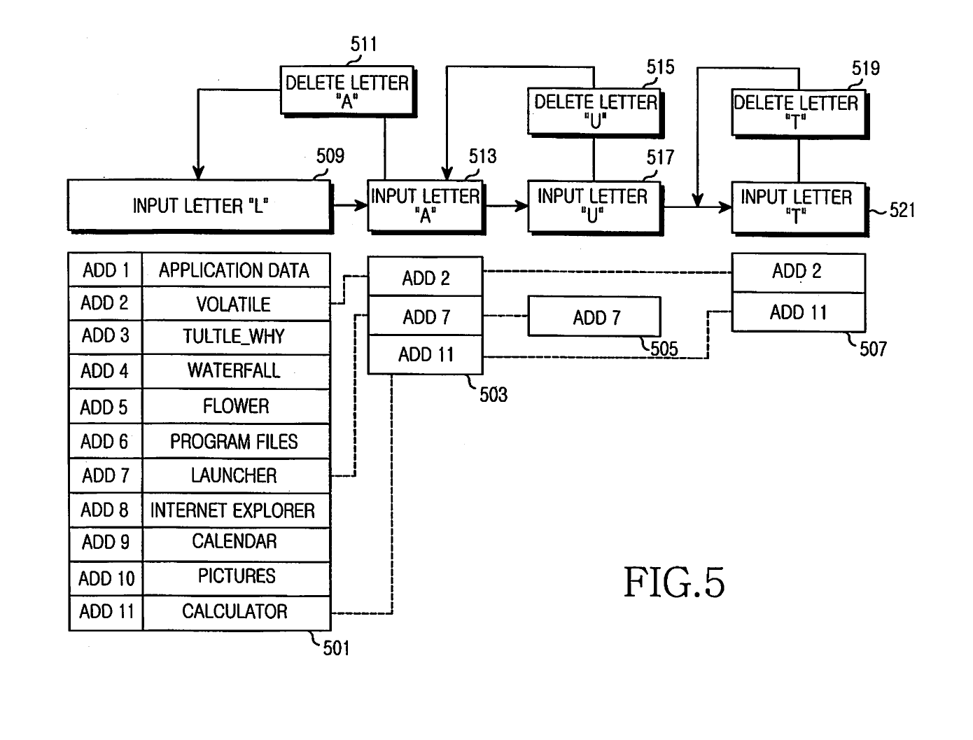

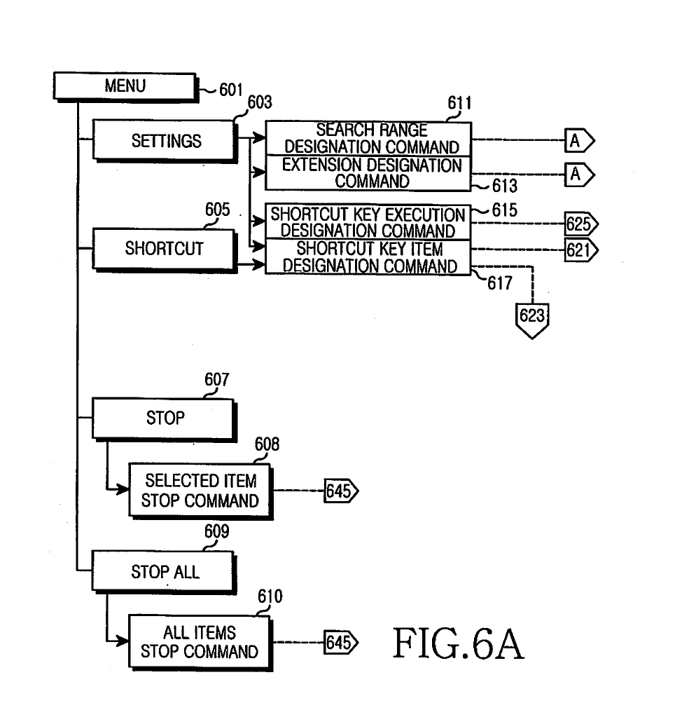

Referring to FIG. 5, when a letter is input to search for an item, a list of previously input words is maintained without re-searching designated directories each time. Thus, the search time can be minimized. In other words, when a first letter is input to start searching for an item, all designated directories are searched to constitute a list. However, when the next letter is input, only contents of a previous list are searched.

For example, if a letter “L” is input in step 509, all objects to be searched in a designated directory are searched to output a list item 501 including the letter “L”. If a letter “A” is input in step 513, a list item 503 containing the letters “LA” is output from list item 501 searched with the letter “L.” Here, if the letter “A” is deleted in step 511, list item 501 searched with the letter “L” is output. If a letter “U” is input in step 517, a list item 505 containing the letters “LAU” is output from list item 503 searched with the letters “LA”. Here, if the letter “U” is deleted in step 515, list item 503 including the letters “LA” is output. If a letter “T” is input in step 521, a list item 507 including the letters “LAUT” is output from list item 503 searched with the letters “LA”. If the letter “T” is deleted in step 519, list item 505 searched with the letters “LAU” is output.

If 1000 objects are to be searched in a designated directory, and 100 items include a letter “L”, 1000 comparisons are performed to search for items including the letter “L”. However, after a letter “A” is input, only 100 comparisons are performed. Thus, the search time can be reduced. If the letter is deleted, the current list may be converted to a previous list without re-searching for items. Thus, the search time can be reduced. However, when the previous list is maintained, memory efficiency may be impaired. Thus, all pieces of information about the items are not maintained as a list, but only the addresses of the items belonging to a first list are maintained from a first list to a second list. As a result, only minimum memory is used.

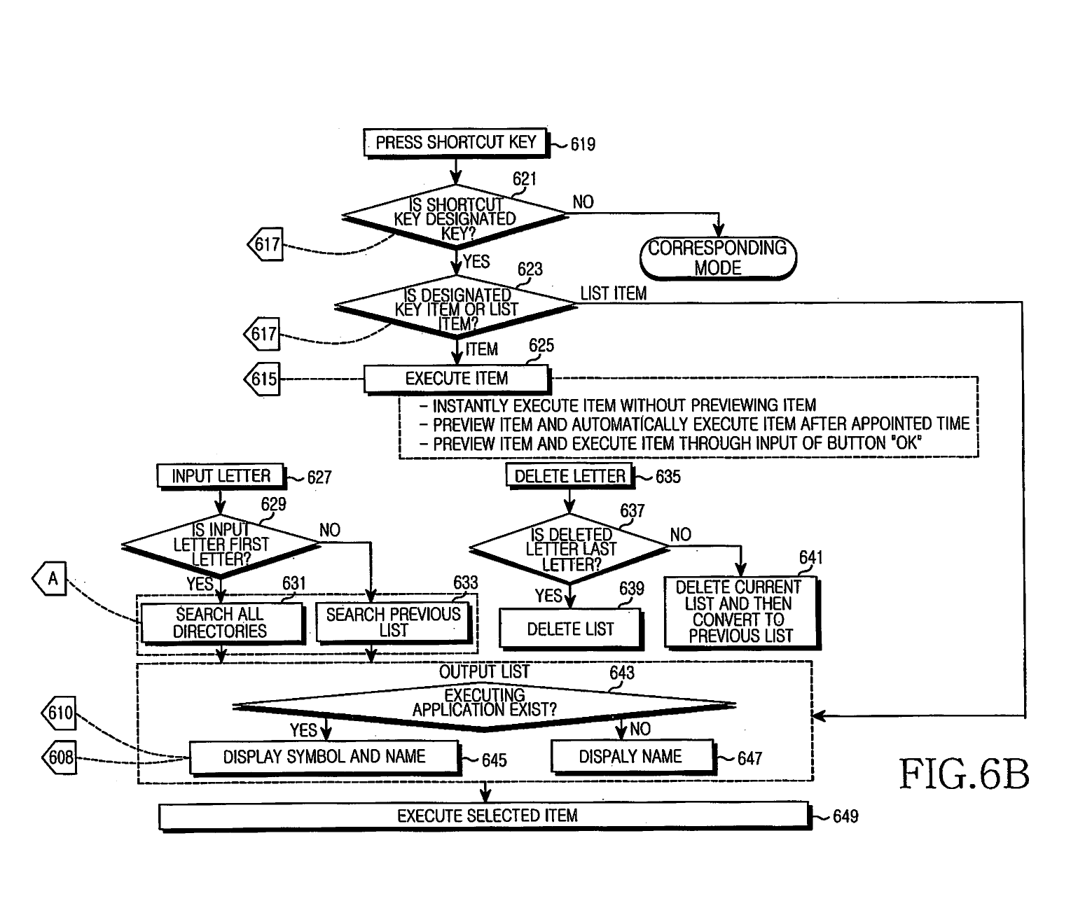

Referring to FIGS. 6A and 6B, a menu 601 of a launcher program is divided into submenus “Settings” 603, “ShortCut” 605, “Stop” 607, and “Stop All” 609.

The submenu “Settings” 603 includes a search range designation command 611, an extension designation command 613, and a shortcut key execution designation command 615. The function of the submenu “Settings” 603 is set according to the preference of a user to minimize unnecessary searches and more quickly and easily execute an item.

Submenus of the search range designation command 611 will be described below.
All Directories: Search all directories in a system.
Designation of Directories to be Searched: Separately designate directories to be searched.
Designation of Directories to be Excluded from Searches: Designate directories to be excluded from searches.

The extension designation command 613 is to designate/release all classification units or designate/release individual extensions in the classification units.
Application: .exe, Ink
URL: .url
Document: .doc, .ppt, etc.
Multimedia: .jpg, .wmv, etc.
Folder

Submenus of the shortcut key execution designation command 615 will be described below.
Instantly execute an item without previewing the item.
Preview an item and then automatically execute the item (after an appointed time).
Preview an item and then execute the item through an input of a button “OK”,

Submenus of the shortcut key item designation command 617 will be described below.
Designate individual items.
Designate list items (an application which is being executed, all applications, URL files, .doc files, etc.).

Submenu “ShortCut” 605 refers to a shortcut key item designation command 617 to select a specific item from selected list items and execute the specific item using a shortcut key.

Submenu “Stop” 607 refers to a selected item stop command 608 to select and stop a specific application among applications which are being executed, wherein the applications belong to the selected list items.

Submenu “Stop All” 609 refers to an all item stop command 610 to stop all applications which are being executed, wherein the all applications belong to the selected list items.

The process of pressing a shortcut key to execute an item includes: step 619 of pressing a shortcut key; step 621 of confirming if the shortcut key is a designated key; step 623 of confirming whether the designated key is an item or a list item; step 625 of executing the item; step 643 of confirming if an executing application exists; step 645 of displaying a symbol ( [symbol] ) and a name; and step 647 of displaying the name.

The designated key and the item or list item must be registered with shortcut keys by a user according to the shortcut key item designation command 617 of submenu “ShortCut” 605 of menu 601. The shortcut key execution designation command 617 of submenu “Settings” 603 of menu 601 must be executed to perform step 625.

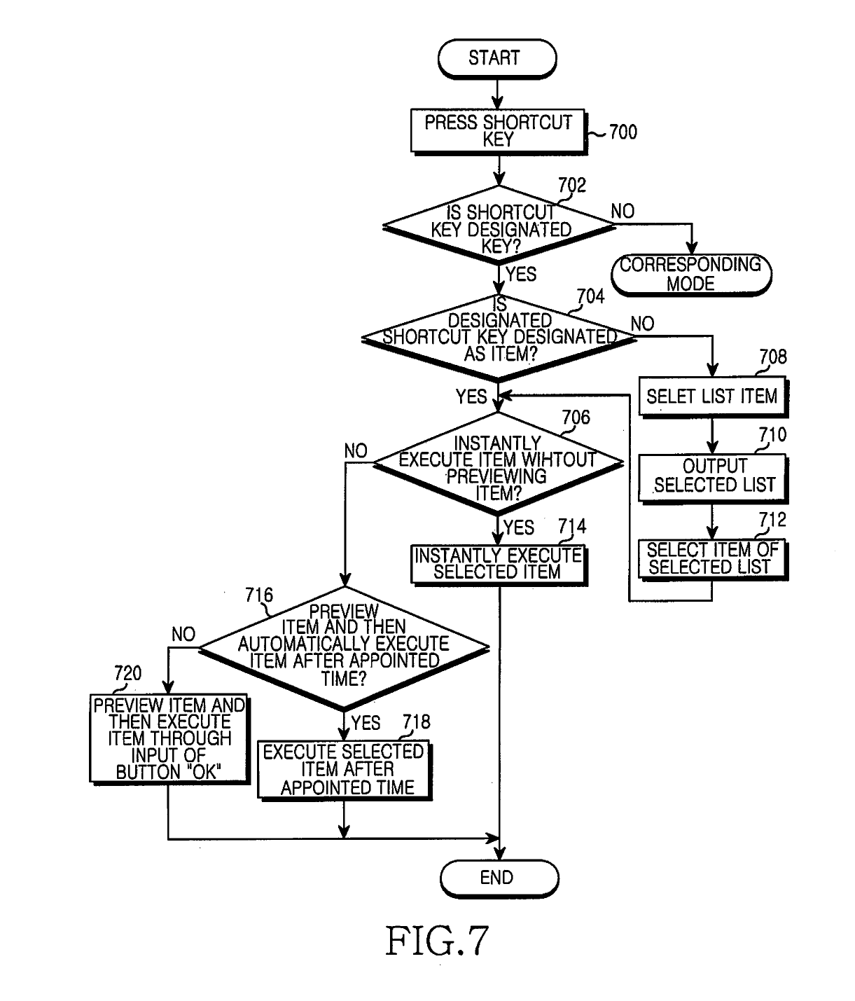

A method of executing an application using a shortcut key will be described in detail later with reference to FIG. 7.

The process of inputting letters to set an item includes step 627 of inputting a letter; step 629 of confirming if the input letter is a first letter; step 631 of searching all directories; step 633 of searching a previous list; step 635 of deleting the letter; step 637 of confirming if the deleted letter is a last letter; step 639 of deleting a list; step 641 of deleting a current list and then converting to the previous list; step 643 of confirming if the application which is being executed exists; step 645 of displaying the symbol and the name; and step 647 of displaying the name.

Settings related to searching of a list in the input of the letter are performed according to the search range designation command 611 and extension designation command 613 of submenu “Settings” 603. An application, being executed, selected from output list items stops or all application being executed stop according to submenus “Stop” 607 and “Stop All” 609.

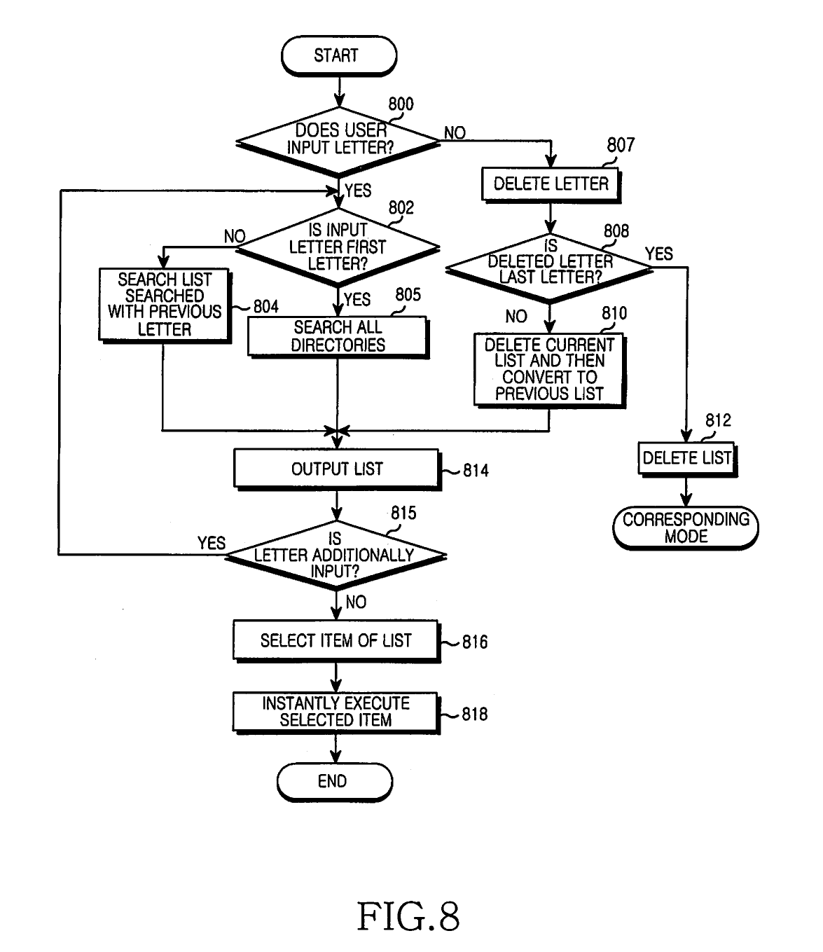

A method of executing an application through an input of a letter will be described in detail later with reference to FIG. 8.

Referring to FIG. 7, a user presses a shortcut key for a long pressing time in step 700 in order to execute an item on an initial screen of the launcher program.

The process proceeds to step 702 to check if the shortcut key is a designated key. In other words, a check is made as to whether the shortcut key is designated as a shortcut key item designation command 617.

If the shortcut key is not the designated key in step 702, a corresponding mode is performed. The corresponding mode may be an initial screen of the launcher program or a message that an error has occurred may be displayed.

If the shortcut key is the designated key in step 702, the process proceeds to step 704 to check if the designated shortcut key is designated as an item. In other words, a check is made as to whether a key designated as a shortcut key is connected to an item (an application, a media file, a document file, or the like).

If the shortcut key is not designated as the item in step 704, the process goes to step 708 to select a list item. The list item may be an item including an application being executed, all applications, URL files, .doc files, etc., which are executed according to a shortcut key item designation command of a menu.

The selected list is output in step 710. Next, the process goes to step 712 to select an item of the selected list and then goes to step 706. The process of executing the item using the shortcut key is ended.

If however, the shortcut key is designated as the item in step 704, the process goes to step 706 to check if the item is set to be instantly executed without being previewed.

If the item is set to be instantly executed without being previewed in step 706, the process goes to step 714 to instantly execute a selected item.

If the item is not set to be instantly executed without being previewed in step 706, the process goes to step 716 to check if the item is set to be previewed and then automatically executed after an appointed time.

If the item is set to be previewed and then automatically executed after the appointed time in step 716, the process proceeds to step 718 to execute the selected item after the appointed time; if not the process goes to step 720 to preview the item and execute the item through an input of a button “OK.”

Referring to FIG. 8, in step 800, a determination is made as to whether a user inputs a letter into an input window to execute an item on an initial screen of the launcher program.

If the user does not enter the letter in step 800, the process goes to step 807 to delete a letter.

In step 808, a determination is made as to whether the deleted letter is the last letter. If the deleted letter is the last letter in step 808, the process goes to step 812 to delete a list. Then, a corresponding mode is performed. Here, the corresponding mode refers to an initial screen of the launcher program.

If the deleted letter is not the last letter in step 808, the process goes to step 810 to delete a current list and then convert to a previous list. The process goes to step 814.

If the letter is entered in step 800, the process proceeds to step 802 to check if the input letter is a first letter.

If the input letter is not the first letter in step 802, the process goes to step 804 to search a list searched with a previous letter. For example, if the letter “A” is entered after a first letter “L,” items including the letters “LA” are searched from a list searched with the first letter “L.” The process goes to step 814 to output the searched list.

If the input letter is the first letter in step 802, the process goes to step 805 to search all directories for items including the first letter.

In step 814, items including the input letter are searched to output a list.

The process goes to step 815 to check if a letter is additionally entered. If the letter was additionally entered, the process returns to step 802. If the letter is not additionally entered in step 815, the process goes to step 816 to select an item of the searched list. In step 818, the selected item is instantly executed.

The process of executing the item using the input letter is ended.

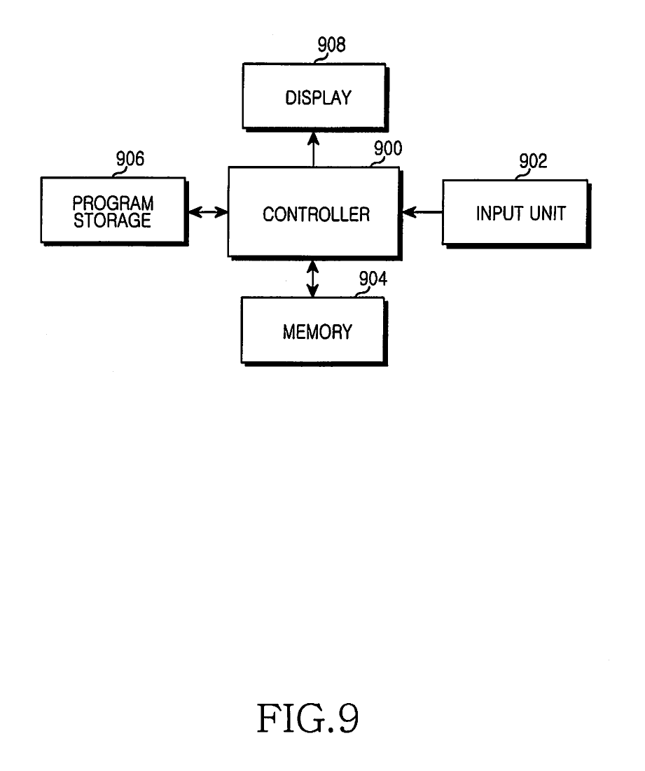

Referring to FIG. 9, a controller 900 controls the overall operation of a portable terminal. For example, according to the present invention, controller 900 performs processing and controlling for a voice call and a data communication. Besides the normal function of performing the processing and controlling, controller 900 recognizes a shortcut key preset in environments of the launcher program or an input letter to confirm if the preset shortcut key is designated as an individual item or a corresponding list item. If the preset shortcut key is designated as the individual item, controller 900 displays a number of the preset shortcut key and a name of the individual item and executes an individual item stored in a program storage 906 according to a shortcut key execution designation command.

Memory 904 stores various types of updatable storage data including a phone book and transmitted and received messages. In particular, memory 904 stores list items, which are searched by controller 900 in the environments of the launcher program, besides the normal function of storing the updatable storage data.

An input unit 902 includes a plurality of function keys including numerical keys, a menu key, a cancel (delete) key, a confirm key, a talk key, an end key, an Internet access key, a navigation key (or direction key), etc. Input unit 902 also provides key input data corresponding to a key pressed by a user to controller 900.

A display 908 displays state information, limited numerical letters, a large amount of moving and still pictures, etc. generated during an operation of the portable terminal. In particular, according to the present invention, display 908 displays the list items searched by controller 900 in the environments of the launcher program, besides the normal displaying function.

A program manager 906 stores the individual item. In other words, program manager 906 installs application programs to execute a corresponding application or a corresponding application opening a media or document file according to an instruction of controller 900.

Exemplary embodiments of the present invention can also comprise computer readable codes on a computer readable medium. The computer readable medium can comprise any data storage device that can store data that can be read by a computer system. Examples of a computer readable medium include magnetic storage media (such as, ROM, floppy disks, hard disks, among others), optical recording media (such as, CD-ROMs, or DVDs), and storage mechanisms such as carrier waves (such as, transmission through the Internet). The computer readable medium can also be distributed over network coupled computer systems so that the computer readable code is stored and executed in a distributed fashion. Also, functional programs, codes, and code segments for accomplishing exemplary embodiments of the present invention can be construed by programmers of ordinary skill in the art to which the present invention pertains.

In accordance with the present invention as described above, a letter can be searched or a shortcut key can be used to quickly and easily execute an item desired by a user, wherein the item is one of executable items in a portable terminal.

While the invention has been shown and described with reference to certain preferred embodiments thereof, it will be understood by those skilled in the art that various changes in form and details may be made therein without departing from the spirit and scope of the invention as further defined by the appended claims.

What is claimed is:

1. A method of executing an application in a portable terminal, comprising:
checking if a shortcut key preset in a launcher program is input;
determining whether the preset shortcut key is designated as an individual item or a list item;
displaying a number of the preset shortcut key and a name of the individual item if the preset shortcut key is designated as the individual item; and
executing the individual item according to the shortcut key.

2. The method of claim 1, wherein the individual item is one of an application, a file, and a folder.

3. The method of claim 1, wherein the launcher program includes a task manager function which displays an application being executed and stops the application if necessary.

4. The method of claim 1, further comprising, if the preset shortcut key is designated as the list item, outputting the list item and selecting and executing at least one item of the output list.

5. The method of claim 4, wherein the output list provides functions of displaying whether an application is being executed or not and stopping the application being executed.

6. The method of claim 4, wherein the output list includes individual items searched

7. The method of claim 1, wherein the executing the individual item is one of instantly executing the item without previewing the item, previewing the item and then automatically executing the item after an appointed time, and previewing an item and executing the item according to a user input.

8. A method of executing an application in a portable terminal, comprising:
inputting a letter to a launcher program;
outputting a list searched for items containing the input letter; and
selecting and executing at least one of the items in the output list.

9. The method of claim 8, wherein the item is one of an application, a file, and a folder.

10. The method of claim 8, wherein the launcher program includes a task manager function, which displays an application being executed and stops the application if necessary.

11. The method of claim 8, wherein a range for searching for the items is one of all directories, at least one directory to be selected, and all directories except at least one directory to be selected.

12. The method of claim 8, wherein if the letter is entered into the input search window, all directories are searched for items containing a first letter to output the searched items, and a list searched with a previous letter is searched for items containing a second letter.

13. An apparatus for executing an application in a portable terminal, comprising:
a controller for checking if a shortcut key preset in a launcher program is input, determining if the preset shortcut key is designated as an individual item or a list item, displaying a number of the preset shortcut key and a name of the individual item if the preset shortcut key is designated as the individual item, and executing the individual item according to the shortcut key; and
a program storage storing the individual item.

14. The apparatus of claim 13, wherein the individual item is one of an application, a file, and a folder.

15. The apparatus of claim 13, wherein the launcher program includes a task manager function, which displays an application being executed and stops the application if necessary.

16. The apparatus of claim 13, wherein if the preset shortcut key is designated as the corresponding list, the controller outputs the corresponding list and selects and executes at least one item of the output list.

17. The apparatus of claim 16, wherein the output list provides function of displaying whether an application is being executed or not and stopping the application being executed.

18. The apparatus of claim 16, wherein the output list includes individual items searched.

19. The apparatus of claim 13, wherein the executing the individual item is one of instantly executing the item without previewing the item, previewing the item and then automatically executing the item after an appointed time, and previewing the item and executing the item according to a user input.

20. An apparatus for executing an application in a portable terminal, comprising:
an input unit inputting a letter to a launcher program;
a controller searching for items containing the input letter to output a list item, and if at least one item is selected from the output list item, executing the selected item; and
a program storage storing the selected item.

21. The apparatus of claim 20, wherein the item is one of an application, a file, and a folder.

22. The apparatus of claim 20, wherein the launcher program includes a task manager function, which displays an application being executed and stops the application if necessary.

23. The apparatus of claim 20, wherein a range for searching for the items is one of all directories, at least one directory to be selected, and all directories except at least one directory to be selected.

24. The apparatus of claim 20, wherein if the letter is entered into the input search window, all directories are searched for items including a first letter to output the searched items, and a list searched with a previous letter is searched for items including a second letter.

25. A computer-readable recording medium having recorded thereon a program for executing an application in a portable terminal, comprising:
a first code segment, checking if a shortcut key preset in a launcher program is input;
a second code segment, confirming whether the preset shortcut key is designated as one of an individual item and a list item;
a third code segment, displaying a number of the preset shortcut key and a name of the individual item if the preset shortcut key is designated as the individual item; and
a fourth code segment, executing the individual item according to a shortcut key execution designation command.

26. A computer-readable recording medium having recorded thereon a program for executing an application in a portable terminal, comprising:
a first code segment, inputting a letter into an input search window of a launcher program;
a second code segment, outputting a list searched for items containing the input letter; and
a third code segment, selecting and executing a corresponding item of the output list.
